(19) United States
(12) Patent Application Publication
(10) Pub. No.: US 2009/0304568 A1
(43) Pub. Date: Dec. 10, 2009

(54) Process for Producing Silane

(76) Inventors: Ivar M. Dahl, Oslo (NO); Anja Olafsen, Oslo (NO); Knut Thorshaug, Oslo (NO); Arild G. Andersen, Oslo (NO)

Correspondence Address: WENDEROTH, LIND & PONACK, L.L.P., 1030 15th Street, N.W.,, Suite 400 East, Washington, DC, 20005-1503, US

(21) Appl. No.: 12/086,885

(22) PCT Filed: Dec. 1, 2006
(86) PCT No.: PCT/NO2006/000452

§ 371 Date: Jan. 14, 2009

(30) Foreign Application Priority Data
Dec. 22, 2005 (NO) 2005 6145

(51) Int. Cl. C01B 33/04

(52) U.S. Cl. 423/347

(57) ABSTRACT

The invention describes a process for producing silane, wherein magnesium hydride and halosilanes are reacted into silane and a by-product separable into at least two compounds, in a liquid reaction medium at a temperature T≧100° C. and a reaction time/residence time <60 min, and wherein at least one of said compounds is recycled.

### BACKGROUND

The high purity silicon needed for the semiconductor or solar cell industry is today usually made by pyrolysis of silanes. The production of monosilane from sources of comparatively cheap silicon of lower purity is therefore one of the factors that determine the ultimate cost of the high purity silicon and the devices made from them. This is especially true for solar cell production.

During the production of high purity silane, the silane may contain impurities present in the original silicon raw material, in the hydrogen source, from other chemicals and solvents used in the process, and from processing equipment. To obtain a good result, the raw materials should be as pure as possible, as well as all chemicals put into the process. The consumption of chemicals of high purity will further increase the cost of silane production.

Methods are known for converting silicon halides, which optionally can have additional hydrocarbon groups, into the corresponding silanes by reaction with magnesium hydride.

U.S. Pat. No. 5,455,367 describe a method for the synthesis of silanes or organosilicon hydrides by the reduction of the corresponding silicon halide with a magnesium hydride in a liquid reaction medium. The special magnesium hydride is explained to be “non-pyrophoric storage magnesium” synthesised autocatalytically according to a method of DE 4039278. The essential characteristic of an autocatalytical synthesis is to add at least 1.2 wt % of magnesium hydride, based on the magnesium that is to be hydrogenated. Conventional ethers are used as the reaction medium where magnesium hydride and silicon halides are reacted. The magnesium halide formed on the surface of the magnesium hydride particles during the reaction is continuously removed by the action of mechanical energy or ultrasound so as to form a fresh surface. However, this method needs specially activated Mg which adds costs and time to the silane synthesis process.

In U.S. Pat. No. 5,061,470 silane is produced from reacting halosilanes with hydridomagnesium chloride. Magnesium chloride is formed in the process and the most preferred halosilane is trichlorosilane. The formed magnesium chloride is partly recycled in the process by the reaction with magnesium hydride to form a hydridomagnesium chloride. An excess of about 50% trichlorosilane (relative to HMgCl) is recommended, which gives close to 100% yields of silane. Process temperatures between 50° C. and 60° C. are recommended when using THF (tetrahydrofuran) as solvent. A reaction time of 90 minutes is used. Again, specially prepared hydrido magnesium compounds must be used in the synthesis of silane.

U.S. Pat. No. 4,725,419 describes a cyclic process for the production of silane by reacting highly reactive magnesium hydride with halosilanes to form magnesium halide and silane. Silane is recovered as gas. The reaction is carried out in a solvent for magnesium halide. Magnesium is recovered in the process by reacting magnesium halide with an alkali metal and form an alkali metal halide as by-product. Magnesium is converted to magnesium hydride by pressure hydrogenation. The highly reactive magnesium hydride is formed by the homogeneously catalysed pressure hydrogenation of magnesium, preferably using activated transition metal catalyst such as TiCl₄ and CrCl₃ and a polycyclic organic compound as anthracene. Initial reaction temperatures of 20° C. and yields between 60-95% were obtained after 90 minutes reaction time when the highly reactive MgH₂ is used. Similar experiments, using commercial magnesium hydride, give 16% yield under else similar conditions. A preferred method for preparation of activated magnesium hydride is described by Bogdanovic et al. in Catalytic Synthesis of Magnesium Hydride under Mild Conditions, Angew. Chem. Int. ed. Engl. 19, (1980) 818-819. This is a third example of using specially activated MgH₂ to obtain reasonable reaction times and yields.

EP 0111924 B1 describes a process for preparation of silicon hydrides compounds, in particular of monosilane, from halosilanes (in particular with tetrachlorosilane) reacted with magnesium hydride in a solvent in the absence of additional catalysts/activators. Magnesium hydride is obtained by reacting magnesium with hydrogen in the presence of catalyst consisting of a halide of a metal of subgroups IV to VIII of the periodic system and of an organic magnesium compound or of a magnesium hydride and optionally in the presence of a polycyclic aromatic compound or of a tertiary amine and optionally in the presence of a magnesium halide. The silane production is carried out in the temperature range from 0° C. to 150° C., preferably from 20° C. to 70° C. Both the hydrogenation of magnesium and the subsequent reaction of magnesium hydride with halosilane are carried out as one pot process. However, the extra effort of making magnesium hydride by a lengthy and cumbersome route adds greatly to the cost of this route.

JP 62128915 describes a procedure to produce monosilane in high yield at low cost by reducing silicon halide with the hydride of an alkali metal or an alkali earth metal made soluble in an organic solvent. Of high importance of the invention in JP 62128915, is that the solubility of the hydride (e.g. LiH, MgH₂) is increased by adding a complex-ion such as EDTA. Preferred reaction temperatures are at room temperature to about 200° C. under ordinary (1 atm) or elevated pressure. All examples are at atmospheric pressure (1 atm) and 50-60° C. The use of EDTA adds to the cost of the synthesis, and makes the possible reuse of the by-products less attractive.

### SUMMARY OF THE INVENTION

The present invention is conceived to solve or at least alleviate the problems identified above. Specifically, an object of the invention is to provide a production method which lowers the costs of silane production and reduce the problem with impurities.

The invention provides in an aspect a process for producing silane, wherein magnesium hydride and halosilanes are reacted into silane and a by-product consisting of at least two compounds, in a liquid reaction medium at a temperature T≦100° C. and a reaction time/residence time <60 min, and wherein at least one of said compounds is recycled.

Halosilanes shall be understood as SiH₍ₙ₎X₍₄₋ₙ₎, where X═F, Cl, Br, I or any combination thereof.

In another aspect the invention provides a process for producing silane, wherein magnesium hydride and halosilanes are reacted into silane and a by-product separable into at least two compounds, in a liquid reaction medium at a temperature T≧100° C. and a reaction time/residence time <60 min, and wherein at least one of said compounds is recycled.

Preferably, the reaction time is <30 min, and the temperature T is in the range of 100-150° C., preferably 110-130° C. The degree of recycling of the liquid in the process is >95%, preferably >99%.

The liquid reaction medium may comprise a solvent for magnesium halide. The solvent may be an ether, preferably tetrahydrofuran, but may also be chosen from the group comprising dioxane, diethylether, dimethoxy ethane and dibutyl ether. The by-product may be dissolved in surplus solvent, filtrated, re-crystallized and converted into magnesium halide and solvent. The by-product may be decomposed thermally into the components magnesium halide and solvent. Further, the magnesium halide may be converted to magnesium and halogen. The magnesium may be recycled to magnesium hydride. The halogen may be recycled with silicon and optionally hydrogen to halosilanes. The halosilanes may be trichlorosilane and tetrachlorosilane.

In a further embodiment the by-product comprises magnesium chloride and magnesium chloride as a complexed compound. In this embodiment, the by-product consists of solid magnesium chloride/tetrahydrofuran complex, and MgCl₂ dissolved in THF. The dissolved magnesium chloride and magnesium chloride complex may be decomposed thermally into magnesium chloride and solvent. One or both of these may be recycled to the process.

In the present invention it was surprisingly found that by increasing the temperature and using commercially available magnesium hydride, the reaction time needed for the reaction decreased from >1 week at room temperature (RT) to about 10-30 minutes at 120° C. The observed increase in silane production rate shows an unexpectedly large effect of rising the reaction temperature. However, under such conditions the produced silane may decompose at an important rate even at the relatively low temperature in the reactor.

The invention also provides a production method where essentially all of the process chemicals are recycled. This lowers the chemicals costs, and provides a process where the only impurities may be due to impurities in the original raw material silicon. The invention is defined in the appended claims.

### BRIEF DESCRIPTION OF DRAWINGS

Embodiments of the invention will be described with reference to the following drawings, where:

FIG. 1 shows a total reaction process for the production of silicon of high purity from pure silicon; and

FIG. 2 a) b) shows yield for silane and H₂ at variable experimental conditions (temperature, process time, molar ratios) for the process according to an embodiment of the invention.

### DETAILED DESCRIPTION

The present invention relates in general to magnesium hydride and the reaction thereof with halosilanes to produce silane and in particular to produce silane from magnesium hydride which does not need to be especially activated. Preferred halosilanes are trichlorosilane and tetrachlorosilane. The reaction is performed in a liquid reaction media for the reaction of magnesium hydride and halosilane. Magnesium halide must to some degree (>0.1 g/l) be soluble in this solvent. The solvent shall not contain hydrogen atoms acidic enough to react with magnesium hydride forming hydrogen. The solvent is an ether, which may be chosen from the group comprising tetrahydrofuran, dioxane, diethylether, dimethoxy ethane and dibutyl ether. A more preferred solvent is tetrahydrofuran.

In one embodiment, the chemicals are cycled in a process consisting of the following steps: (Si means for example metallurgical grade silicon, while Si* means silicon of high purity).

A. Si+2Cl₂→SiCl₄

B. 2Mg+2H₂→2MgH₂

C. SiCl₄+2MgH₂+2nTHF→SiH₄+2MgCl₂(THF)ₙ

D. 2MgCl₂(THF)ₙ→2MgCl₂+2nTHF

E. 2MgCl₂-electrolysis→2Mg+2Cl₂

F. SiH₄→Si*+2H₂

Sum reaction: Si→Si*

There are some possibilities for short cuts, i.e. that process A is performed as

A1. 1.5 Cl₂+1.5H₂→3 HCl

A2. Si+3HCl→SiHCl₃+H₂

Net process is then:

AX. Si+1.5Cl₂+0.5H₂→SiHCl₃

This variation reduces the amount of material necessary in the process steps B and E as we may have a new reaction CX.

CX. HSiCl₃+1.5MgH₂→SiH₄+1.5MgCl₂

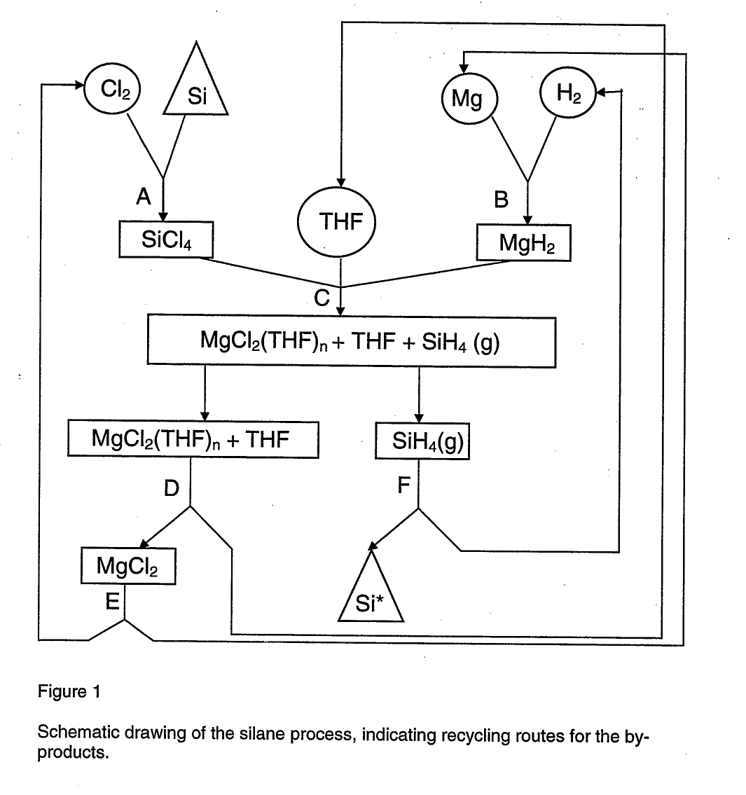

The reaction process above is shown in FIG. 1 to better illustrate the recycling compounds of the present invention.

The time needed for the reactions above determine the size and cost of the process equipment. A doubling of reaction time generally means a necessary doubling of the reaction volume to give the same throughput of the total process.

Step A above may be performed by direct reaction between the gaseous chlorine and solid silicon at temperatures from room temperature to 1000° C. and in a fluidized bed or a fixed bed reactor. Alternatively, the reactions A1-A2 may be performed in any way known in present technology.

Important factors for the total process A-F are the time needed for reactions B and C. In step B, the molten magnesium is brought into a form. The smallest typical magnesium particle dimension is ≦100 μm, preferably ≦40 μm. The hydrogenation takes place at elevated temperatures (300-400° C.) and pressure (4-200 bar), resulting in a reaction time <5 h. The reaction time may be shortened by grinding the magnesium during the hydrogenation step. Relevant literature for these proposed reaction conditions are Schrøder Perdersen et al.; Journal of the Less Common Metals, 131 (1987) 31-40 and Bobet et al.; Journal of Alloys and Compounds 298, (2000), 279-284. A reaction time of 5 h corresponds to a reactor that can handle about 4000 kg Mg for a yearly production of 5000 tons of high purity SiH₄.

To effectuate the reaction C in a short time, specially activated MgH₂ has hitherto been necessary (e.g. U.S. Pat. No. 4,725,419 and references therein and DE 3247362A1), or strong mechanical interaction has been necessary to effectuate the reaction (e.g. U.S. Pat. No. 5,455,367).

It was surprisingly found that by increasing the temperature of step C, and using commercially available magnesium hydride with HₙSiCl₄₋ₙ in tetrahydrofuran (THF), the reaction time needed for the reaction decreased from >1 week at room temperature (RT) to about 20 h at 70° C., to about 10-30 minutes at 120° C. Rising the reaction temperature, results in a pressure >10 bar.

The observed rate increase shows an unexpectedly large effect of rising the reaction temperature.

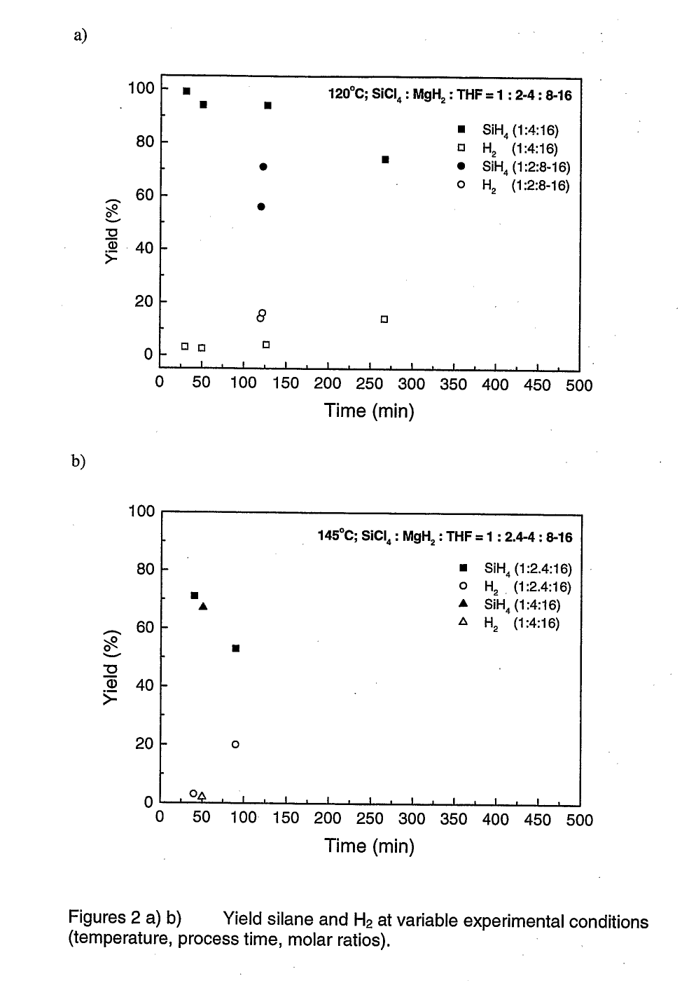

Under such conditions the produced product silane, SiH₄, may decompose to hydrogen and silicon at an important rate even at the relatively low temperature in the reactor (see FIG. 2). This implicate that there exists an optimum in time/temperature for the reaction step C, which is somewhat dependent on the actual reactor configuration.

The quantities of magnesium hydride and tetrachlorosilane, and also for THF, can vary. Preferably, magnesium hydride is always in excess so as to provide enough material for chlorosilane to react with. The reaction between commercial magnesium hydride, which has hitherto been considered as being of very low reactivity, and tetrachlorosilane, is performed in a solvent for magnesium chloride. The solvent is an ether which may be chosen from the group comprising tetrahydrofuran, dioxane, diethylether, dimethoxy ethane and dibutyl ether. Tetrahydrofuran is preferred.

Reaction step C can be performed at any temperature at which magnesium hydride and tetrachlorosilane can form silane. The temperature should be sufficient above room temperature to obtain reasonable reaction rates, preferably above the boiling point of the solvent in a reaction vessel and that can hold the pressure necessarily generated by the solvent and the chlorosilane reagent. The reaction temperature should however be below 200° C. to suppress decomposition of the product silane, and above 100° C. to ensure a high reaction rate for silane formation. Preferably, the reaction temperature is between 100-150° C., and most preferably 110-130° C. At 120° C. the SiCl₄ has reacted almost entirely to SiH₄ within less than 30 minutes (see example 2-14 and Table 1). The silane obtained in the described way may be further purified before being used in the production of high purity silicon.

In step D, the by-product MgCl₂(THF)ₙ, which is separable and effectively consists of the two compounds MgCl₂ and THF, may be dissolved in surplus THF, filtrated and recrystallised as MgCl₂(THF)₄. The recrystallised MgCl₂(THF)₄ is then recycled into MgCl₂ and THF (see example 15). Depending on the purity of the metallurgical grade Si, this solution/recrystallisation step may be unnecessary.

It is possible to effectively only recycle compound THF if only process steps C and D are performed. SiCl₄ and MgH₂ are then supplied to the process from an external source, while the magnesium chloride, obtained in step D may be delivered as a by-product.

Step E represents the electrolytical production of Mg and Cl₂ from molten MgCl₂, such as is commonly performed in current industrial practice.

Step F represents production of high purity Si from silane by pyrolysis, either in a bell jar like reactor such as in the Siemens process, in a fluidised bed reactor, or any other process devised for this purpose.

### EXAMPLES

### Example 1

Under inert conditions 5.68 mmol of commercially available magnesium hydride (MgH₂; Avocado) were mixed with 22.72 mmol of tetrahydrofuran (Riedel-de Haën) and 1.42 mmol SiCl₄ (Aldrich) in a stainless steel reactor. The reactor was sealed in an atmosphere of Ar and immersed in a glycerol bath held at 20° C. The content of the reactor was stirred by a magnet stirrer. The reaction time was 1 week, including heating up the reactor system.

Analysis (GC) disclosed SiH₄ production of 0.05 mmol corresponding to a yield of 3.5% with respect to SiCl₄ and H₂ production of 0.36 mmol corresponding to a yield of 6% with respect to MgH₂.

### Examples 2-14

These reactions were performed as in example 1 except that the temperatures, reaction times and molar ratios of reactants were varied as shown in Table 1. Yields of SiH₄ with respect to SiCl₄ up to 99% were obtained.

In FIG. 2 a), b) the yield of silane (and hydrogen) is presented as a function of reaction time for temperatures 120° C. and 145° C. and for several molar ratios. The curve for the examples performed at 120° C., together with the observation that long reaction times at high temperature gives Si powder, shows that it is important that the product silane not is kept in the reactor at high temperature for a too long time.

TABLE 1

| | H₂ | SiH₄ | Yield | Yield | | T | Time |
|---|---|---|---|---|---|---|---|
| Example | mmol | mmol | H₂ (%) | SiH₄ (%) | | (° C.) | (min) |
| | | | | | SiCl₄:MgH₂:THF | | |
| 1 | ≈0.36 | ≈0.05 | 6 | 3.5 | 1^{a}:4:16 | 23 | 1 week |
| 2 | 0.093 | 1.00 | 3 | 70 | 1:2.4:16 | 145 | 40 |
| 3* | 0.678 | 0.801 | 20 | 56 | 1:2.4:16 | 145 | 90 |
| 4 | 0.373 | 0.953 | 7 | 67 | 1:4:16 | 145 | 50 |
| 5 | 0.149 | 1.41 | 3 | 99 | 1:4:16 | 120 | 30 |
| 6 | 0.144 | 1.33 | 3 | 94 | 1:4:16 | 120 | 50 |
| 7 | 0.243 | 1.34 | 4 | 94 | 1:4:16 | 120 | 127 |
| 8 | 0.820 | 1.07 | 14 | 75 | 1:4:16 | 120 | 267 |
| 9 | 0.091 | 0 | 2 | 0 | 0:4:16 | 120 | 186 |
| 10 | 0.395 | 0.790 | 14 | 56 | 1:2:16 | 120 | 120 |
| 11 | 0.455 | 1.00 | 16 | 70 | 1:2:8 | 120 | 122 |
| 12 | 0.268 | 0.450 | 5 | 32 | 1:4:16 | 70 | 312 |
| 13 | 0.609 | 0.776 | 11 | 55 | 1:4:16 | 70 | 462 |
| | | | | | HSiCl₃:MgH₂:THF | | |
| 14 | 0.596 | 1.05 | 10 | 74 | 1:4:16 | 120 | 50 |

^{a}1 = 1.42 mmol
mmol SiCl₄ = mmol HSiCl₃ = 1.42
Yield SiH₄ (%) = (mmol SiH₄ produced)/mmol SiCl₄)*100
Yield H₂ (%) = (mmol H₂ produced/mmol MgH₂)*100
*Dark powder analysed by EDX, and found to manly consist of Si.

### Example 15

Pure MgCl₂ (Aldrich) was dissolved in excess tetrahydrofuran (Riedel-de Haën) at 40° C. under inert conditions. The obtained solution was dried under vacuum giving rise to formation of a white finely grained powder of mass 3.71 g. A small fraction of the formed powder was investigated by IR, and found to contain bands corresponding to MgCl₂ and tetrahydrofuran.

The obtained powder was then decomposed under vacuum at 175° C. for 12 h to form tetrahydrofuran and MgCl₂. The obtained MgCl₂ had a mass of 0.91 g, which corresponds to a formula of MgCl₂(THF)_{4.06} before the final heat treatment at 175° C.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Process for producing silane, wherein magnesium hydride and halosilanes are reacted into silane and a by-product separable into at least two compounds, in a liquid reaction medium at a temperature T100° C. and a reaction time/residence time <60 min, and wherein at least one of said compounds is recycled.

2. The process according to claim 1, wherein the reaction time is <30 min.

3. The process according to claim 1, wherein the temperature T is in the range of 100-150° C., preferably 110-130° C.

4. The process according to claim 1, wherein said liquid reaction medium comprises a solvent for magnesium halide.

5. The process according to claim 4, wherein the by-product is dissolved in surplus solvent, filtrated, re-crystallized and converted into magnesium halide and solvent.

6. The process according to claim 5, wherein the by-product is decomposed thermally into magnesium halide and solvent.

7. The process according to claim 4, wherein the solvent is tetrahydrofuran.

8. The process according to claim 4, wherein the solvent is an ether.

9. The process according to claim 4, wherein the solvent is chosen from the group comprising dioxane, diethylether, dimethoxy ethane and dibutyl ether.

10. The process according to claim 1, wherein the by-product comprises magnesium chloride, preferably in a dissolved state, and/or magnesium chloride as a complexed compound.

11. The process according to claim 1, wherein the degree of recycling of the liquid is >95%, preferably >99%.

12. The process according to claim 1, wherein said halosilanes are trichlorosilane and tetrachiorosilane.

13. The process according to claim 5, wherein the halide is chloride and the magnesium chloride is converted to magnesium and chlorine.

14. The process according to claim 13, wherein magnesium is recycled to magnesium hydride.

15. The process according to claim 13, wherein chlorine is recycled with silicon and optionally hydrogen to halosilanes.

16. The process according to claim 5, wherein the solvent is tetrahydrofuran.

17. The process according to claim 6, wherein the solvent is tetrahydrofuran.

18. The process according to claim 5, wherein the solvent is an ether.

19. The process according to claim 6, wherein the solvent is an ether.

20. The process according to claim 5, wherein the solvent is chosen from the group comprising dioxane, diethylether, dimethoxy ethane and dibutyl ether.

21. The process according to claim 6, wherein the solvent is chosen from the group comprising dioxane, diethylether, dimethoxy ethane and dibutyl ether.

22. The process according to claim 8, wherein the solvent is chosen from the group comprising dioxane, diethylether, dimethoxy ethane and dibutyl ether.

23. The process according to claim 6, wherein the halide is chloride and the magnesium chloride is converted to magnesium and chlorine.
